(19) United States
(12) Patent Application Publication
(10) Pub. No.: US 2014/0228097 A1
(43) Pub. Date: Aug. 14, 2014

(54) INFORMATION PROCESSING SYSTEM, NON-TRANSITORY COMPUTER-READABLE STORAGE MEDIUM HAVING STORED THEREIN INFORMATION PROCESSING PROGRAM, AND INFORMATION PROCESSING METHOD

(71) Applicant: NINTENDO CO., LTD., Kyoto (JP)

(72) Inventor: Kouichi KAWAMOTO, Kyoto (JP)

(21) Appl. No.: 13/942,943

(22) Filed: Jul. 16, 2013

(30) Foreign Application Priority Data
Feb. 8, 2013 (JP) 2013-022830

(51) Int. Cl. A63F 13/30

(52) U.S. Cl. CPC A63F 13/12
USPC 463/25

(57) ABSTRACT

An example of a system includes a game apparatus and a selling server. In the game apparatus, a game application A1 is executed in accordance with an operation of a user, and game points are given that vary depending on the result of the execution of the game A1. After the game points have been given, the game apparatus accesses a selling server to purchase a game application A2. The selling server calculates a discounted price by subtracting the number of game points from the list price of the game application A2, and makes a settlement for the discounted price in accordance with a determination of a purchase from the game apparatus.

### CROSS REFERENCE TO RELATED APPLICATION

The disclosure of Japanese Patent Application No. 2013-022830, filed on Feb. 8, 2013, is incorporated herein by reference.

### FIELD

The technology disclosed herein relates to a non-transitory computer-readable storage medium having stored therein an information processing program for selling a selling target, and an information processing system and an information processing method for selling a selling target.

### BACKGROUND AND SUMMARY

Conventionally, there is a game where points are given in accordance with an operation of a player in a certain game. For example, there is a game where, if a player character has won a battle with an enemy character, points are given, and a player can play the game to the player's advantage using the given points.

In a conventional technique, however, the points given as the result of the execution of an application can be used only in the same application, and the given points cannot be used for various purposes.

Therefore, it is an object of an exemplary embodiment to provide a technique capable of using the result of the execution of an application for various purposes.

To achieve the above object, the exemplary embodiment employs the following configurations.

An exemplary embodiment is an information processing system, including a user terminal and a server, for selling a selling target. The information processing system includes an execution unit, a generation unit, a calculation unit, and a settlement execution unit. The execution unit executes a first application in accordance with an operation of a user. The generation unit, in accordance with a result of the execution of the first application based on the operation of the user, generates point data indicating a point to be used to discount the selling target. The calculation unit calculates, as discounted price data, a discounted price by subtracting a discount based on the point data from a predetermined price for purchasing the selling target. The settlement execution unit makes a settlement for the selling target on the basis of the discounted price data.

In addition, in another configuration, the selling target may be able to be used in the user terminal.

In addition, in another configuration, the information processing system may further comprise a storage control unit configured to store the point data in a storage unit so that the point data can be used even after the execution of the first application ends. The calculation unit may read at predetermined timing the point data stored in the storage unit, and may calculate the discounted price data using the read point data.

In addition, in another configuration, the point data may be generated on the basis of at least any one of the number of times the first application has been executed, an execution time of the first application, and data that varies depending on the operation of the user during the execution of the first application.

In addition, in another configuration, the information processing system may further comprise a control unit configured to repeat processing performed by the execution unit and the generation unit. The generation unit adds currently generated point data to previously generated point data.

In addition, in another configuration, the information processing system may further comprise a presentation unit configured to present to the user the discounted price indicated by the discounted price data calculated by the calculation unit.

In addition, in another configuration, the settlement execution unit may make the settlement on the basis of the discounted price data in accordance with a determination of a purchase of the selling target, the determination made by the user.

In addition, in another configuration, the calculation unit may calculate the discounted price data so that the discounted price does not become 0.

In addition, in another configuration, the selling target may be a second application different from the first application.

In addition, in another configuration, the execution unit may be able to execute also the second application. The generation unit may generate the point data also in accordance with a result of the execution of the second application, in addition to the result of the execution of the first application.

In addition, in another configuration, the selling target may be data for providing an extension function of the first application.

In addition, in another configuration, the selling target may be data to be used in a second application different from the first application.

In addition, in another configuration, the execution unit may be able to execute also the extension function of the first application. The generation unit may generate the point data also in accordance with a result of the execution of the extension function of the first application, in addition to the result of the execution of the first application.

In addition, in another configuration, the information processing system may further comprising a selection unit configured to allow the user to choose whether or not to use the point data when purchasing the selling target. If the user has chosen to use the point data, the settlement execution unit may make the settlement on the basis of the discounted price data.

In addition, in another configuration, the settlement execution unit may make the settlement using actual currency by a credit card, a prepaid card, prepaid electronic money, bank transfer, an external settlement service, or the like.

It should be noted that the information processing system may include a plurality of apparatuses, and the processing performed by the information processing system may be executed by any of the apparatuses included in the information processing system. Further, another exemplary embodiment may be a server (a system including one or more apparatuses) included in the information processing system. Further, another exemplary embodiment may be an information processing program or may be an information processing method.

These and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is a diagram showing a non-limiting example of an overview of a game application selling system 1 according to an exemplary embodiment;

FIG. 2 is a diagram showing a non-limiting example of the configuration of a game A according to the exemplary embodiment;

FIG. 3 is a diagram showing a non-limiting example of the state where game points are earned and saved in a selling server 30;

FIG. 4 is a diagram showing a non-limiting example of the state where game points are earned by executing a game multiple times;

FIG. 5 is a diagram showing a non-limiting example of the state where game points are earned by playing already purchased games, and the price of a next game is discounted using the earned game points;

FIG. 6 is a diagram showing a non-limiting example of the history of purchasing game applications, which is saved in the selling server 30;

FIG. 7 is a diagram illustrating a non-limiting example of a settlement method using a prepaid card;

FIG. 8 is a diagram showing non-limiting examples of a purchase target for which game points can be used;

FIG. 9 is a diagram showing a non-limiting example of an overview of a selling system according to another embodiment;

FIG. 10 is a diagram showing a non-limiting example of a system using cloud computing, according to another embodiment;

FIG. 11 is a flow chart showing non-limiting examples of details of the processing performed by a game apparatus 10;

FIG. 12 is a flow chart showing non-limiting examples of details of game processing (step S102) in FIG. 11;

FIG. 13 is a flow chart showing non-limiting examples of details of a purchasing process (step S104) in FIG. 11;

FIG. 14 is a flow chart showing non-limiting examples of details of the processing performed by the selling server 30; and

FIG. 15 is a diagram showing a non-limiting example of an image displayed on a display unit 11 of the game apparatus 10.

### DETAILED DESCRIPTION OF NON-LIMITING EXAMPLE EMBODIMENTS

### Overall Configuration of System

With reference to the drawings, a game application selling system 1 according to an exemplary embodiment is described. FIG. 1 is a diagram showing an overview of the game application selling system 1 according to the exemplary embodiment. As shown in FIG. 1, the system 1 includes a game apparatus 10A, a selling server 30, and a credit card company server 50.

The game apparatus 10A is, for example, a handheld game apparatus (or a stationary game apparatus) used by a user A. The game apparatus 10A includes: a CPU for performing game processing; a RAM; a non-volatile memory for storing a game application; a display unit for displaying an image; an operation unit to be operated by a user; and a communication unit for connecting to a network (for example, the Internet). It is assumed that in the non-volatile memory of the game apparatus 10A, a game application A1 and a program for performing processing described later are saved.

The selling server 30 is, for example, a server for selling a game application that is a selling target. The selling server 30 includes: a CPU for performing processing described later; a RAM; a storage device for storing game applications (a game application A2 and a game application A3) that are selling targets (purchase targets), and the like; and a communication unit for connecting to a network. The selling server 30 is connected to a network (for example, the Internet) and is accessed by the game apparatus 10A. Further, the selling server 30 is also accessed by a game apparatus 10B used by a user B, a game apparatus 10C used by a user C, and the like. Further, in the storage device of the selling server 30, a data storage area is provided to store data corresponding to each of the game apparatuses 10A to 10C (each of the users) (each game apparatus will also be referred to as the “game apparatus 10”).

When the user A, using the game apparatus 10A, has executed the game application A1 to play the game A1, game points are given in accordance with the result of the execution of the game application A1. The game points are given by an amount based on the game operation of the user and are used to discount a selling target. The game points may be used to discount the selling target such that an amount is represented by a numerical value and the discount is made by an amount of money based on the represented amount, or such that the discount is made by a predetermined amount of money, using the game points once as with a coupon. Here, such game points are simply referred to as “game points”.

The given game points are transmitted to the selling server 30, and data indicating the game points is stored in a data storage area included in the selling server 30 and corresponding to the game apparatus 10A. For example, it is assumed that in the data storage area for the game apparatus 10A, 20 points are stored as game points.

A description is given of the case where, in this state, the user A accesses the selling server 30 to purchase a game application. When the game apparatus 10A has accessed the selling server 30, a list of applications that can be purchased in the selling server 30 is displayed, and the user A selects, for example, the game application A2 as a purchase target. It is assumed that the list price of the game application A2 is, for example, 100 yen.

Here, the game apparatus 10A (the user A) holds 20 points as game points. The selling server 30 calculates a discounted price (80 yen) by subtracting the number of the game points (20) from the list price (100 yen) of the game application A2, and presents the discounted price to the game apparatus 10A.

Next, the user A determines the purchase of the game application A2 and performs an operation based on the determination. The game apparatus 10A transmits, to the selling server 30, data based on the operation of determining the purchase, and the selling server 30 performs a charging process (a settlement process). For example, as the charging process, the selling server 30 acquires, from the game apparatus 10A, information including a credit card number and a name of the user A and the price, and transmits the information to the credit card company server 50, thereby inquiring whether or not the price can be charged. The selling server 30 receives the result of the inquiry from the credit card company server 50. If the price can be charged, the selling server 30 determines that the charging (settlement) has ended successfully. Then, the selling server 30 transmits the game application A2 that is the purchase target to the game apparatus 10A. Thereafter, the credit card company sends the user A a bill, and the user A pays the charged price.

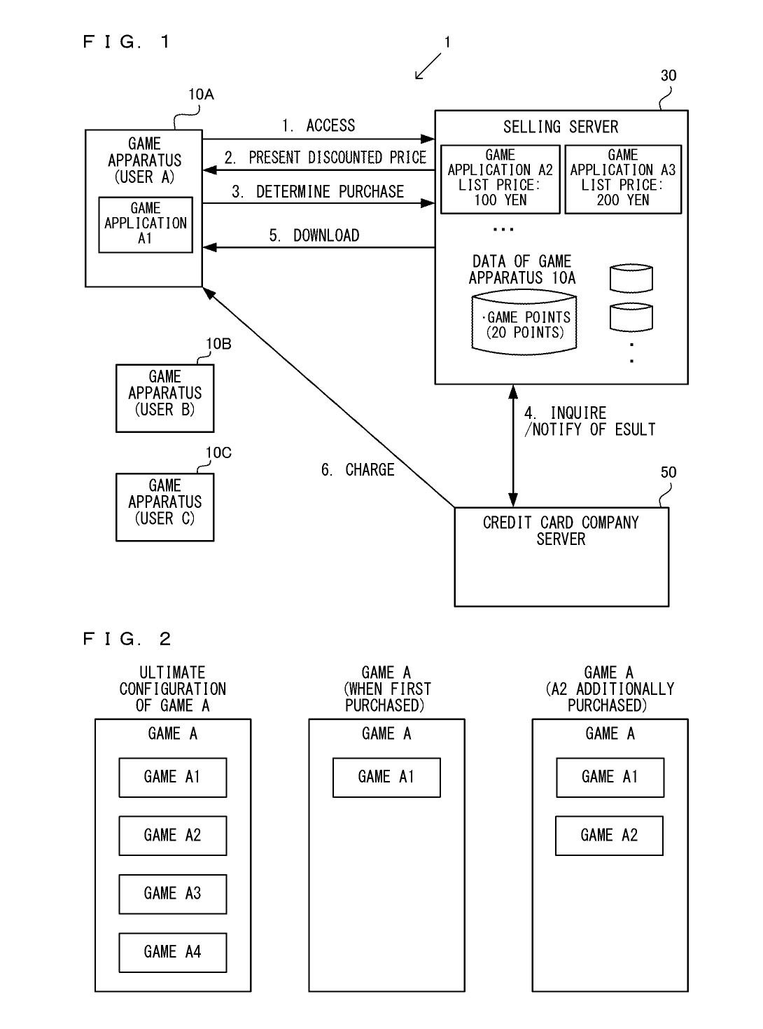

FIG. 2 is a diagram showing an example of the configuration of the game A according to the exemplary embodiment. As shown in FIG. 2, the game A includes mini-games A1 to A4 related (or not related) to one another. Each of the games A1 to A4 is a game that can be executed alone. When the user A has first purchased the game A, the game A includes only the game A1. For example, the user A can purchase a computer-readable storage medium (a non-volatile memory, an optical disk, or the like) having stored therein the game A (the game A1) from a retailer, or can purchase the game A by downloading it from the selling server 30. It should be noted that the game A1 may be provided to the user free of charge.

When the user A has additionally purchased the game A2 from the selling server 30, the purchased game A2 is incorporated into the game A as a part thereof. The games A2 to A4 are thus additionally purchased, thereby ultimately forming the game A including the games A1 to A4. As described above, the prices of the games A2 to A4 to be additionally purchased are discounted using the game points that can be earned by playing an already purchased game (only the game A1 when the game A has been first purchased).

It should be noted that the user A can purchase the games A2 to A4 not only by downloading them from the selling server 30, but the user A may also be able to purchase, for example, storage media having stored therein the games A2 to A4 from a retailer.

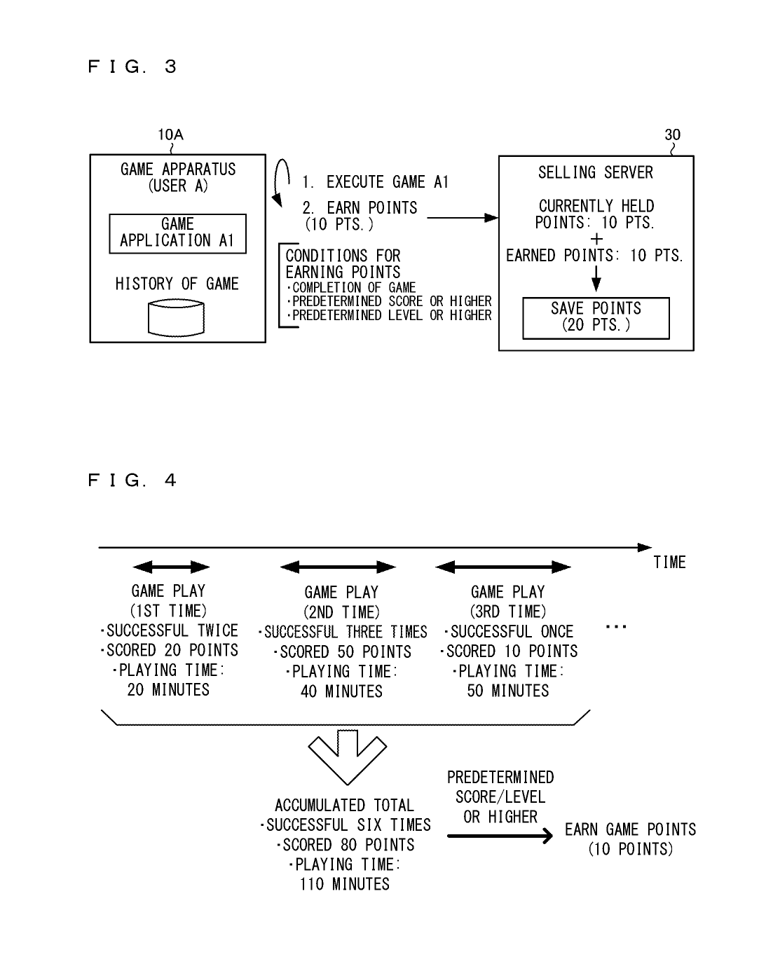

FIG. 3 is a diagram showing the state where game points are earned and saved in the selling server 30. First, the user A, using the game apparatus 10A, executes the game A1, which can be played when the game A has been first purchased. The game A1 may be any game such as a racing game, a fighting game, or a role-playing game. The user A can earn game points in accordance with the result of the execution of the game A1. The game apparatus 10A stores data indicating the history of the game, which varies depending on the game operation of the user A, and game points are given in accordance with the history. Examples of conditions for earning game points may include: the completion of the game A1; the fact that a predetermined score or higher has been obtained during the game; and a predetermined level or higher has been reached during the game. That is, the more successfully the user A plays the game A1 by a game operation using the operation unit of the game apparatus 10A, the more game points the user A can earn.

When the game A1 has been executed using the game apparatus 10A and game points have been given, information indicating that the game points have been given (point information) is saved in the game apparatus 10A. Next, the game apparatus 10A connects to the selling server 30 at predetermined timing (for example, at the end of the game A1) and transmits to the selling server 30 the point information saved in the game apparatus 10A. Then, the selling server 30 adds, to the number of points currently held by the game apparatus 10A, the number of points indicated by the transmitted point information, and saves the resulting number of points.

It should be noted that game points may not only be earned every time the game is performed once, but also be earned by executing the game multiple times. FIG. 4 is a diagram showing an example of the case where game points are earned by executing a game multiple times.

As shown in FIG. 4, it is assumed that the user A plays and ends a game for the first time, then plays the game for the second time, and then plays the game for the third time. When the game has been performed for the first time, the result of playing the game A1 is saved in the game apparatus 10A. Examples of the result of the game performed for the first time, which is saved may include information indicating “successful twice”, “scored 20 points”, “playing time: 20 minutes”. The result of the game may be saved on any scale so long as it varies depending on the result of playing the game.

After the game performed for the first time has ended, even if the game apparatus 10A has been powered off, the result of the game performed for the first time is saved in the game apparatus 10. In this state, the game is started and ends for the second time, and the result of the game performed for the second time is saved. Further, the game is started and ends for the third time, and the result of the game performed for the third time is saved. Then, the results of the game played multiple times are accumulated. If the accumulated results satisfy a predetermined condition (for example, the user has been “successful” five times or more, or has scored 80 points or more), game points may be given. It should be noted that game points may be given not on the basis of what varies depending on the operation of the user A during the game (for example, the number of acquired items, the score, the number of successes, and the number of wins), but on the basis of the number of times the game A1 has been executed, the total playing time of the game A1, or the like.

As described above, in the exemplary embodiment, game points are given in accordance with the result of the game (the game A1) performed using the game apparatus 10, and the given game points are used to discount another game application (the game application A2) when purchasing it. That is, a discounted price of the game application A2 is calculated by subtracting the game points from the list price of the game application A2, and the discounted price is charged (a settlement is made for the discounted price). The more the user A plays the game A1, the more game points the user A can earn. This enables the user A to purchase the game application A2 at a lower price.

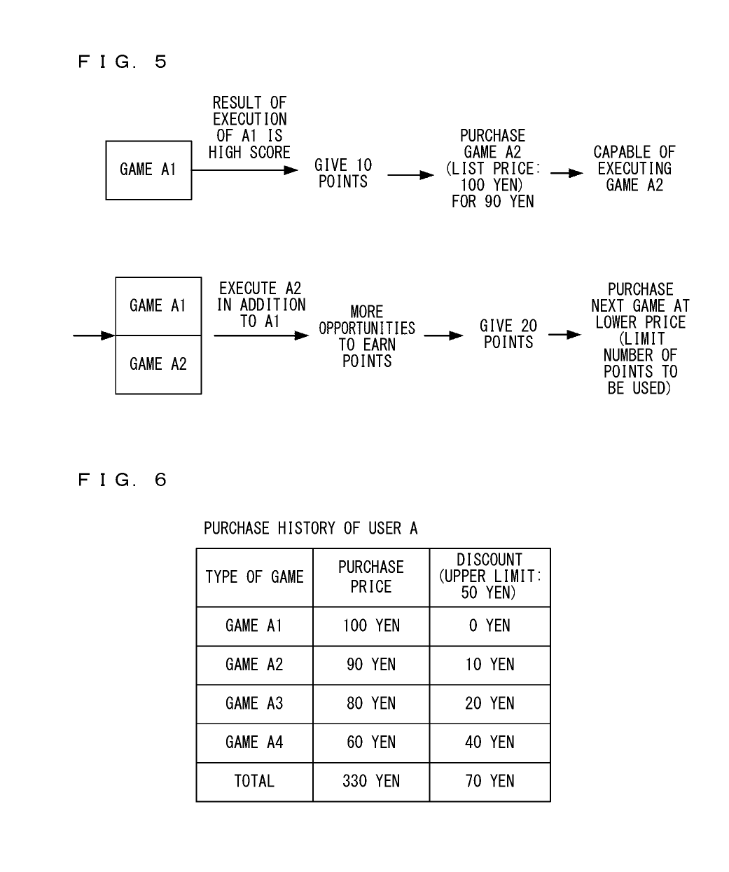

It should be noted that the user A can earn game points also by playing the newly purchased game A2. FIG. 5 is a diagram showing the state where game points are earned by playing already purchased games, and the price of a next game is discounted using the earned game points.

As shown in FIG. 5, if the result of the execution of the game A1 played by the user A is a high score, for example, 10 points are given as game points. When purchasing the game A2 whose list price is 100 yen, the user A can purchase the game A2 for 90 yen using the given game points (10 points). After purchasing the game A2, the user A can newly execute the game A2, and therefore can execute both the games A1 and A2. Thus, the user A has more opportunities to earn game points by playing the games A1 and A2. This enables the user A to earn, for example, 20 points as game points. The user A can use the earned game points when purchasing a next game (the game A3 or the game A4).

It should be noted that an upper limit may be placed on the number of the game points that can be used when newly purchasing a game application. Further, an upper limit may be placed on the number of the game points that can be earned (the number of the game points that can be accumulated). Further, the simultaneous use of a discount based on game points and another discount (a limited-period sale or the like) may be limited.

The history of purchasing game applications is, for example, saved in the selling server 30. FIG. 6 is a diagram showing the history of purchasing game applications, which is saved in the selling server 30. As shown in FIG. 6, in the purchase history, the purchase price and the discount of each game application may be stored, and the total amount of money required to purchase the entire game A including the games A1 to A4 may be stored. The saving of the purchase history also makes it possible to cause users to compete with each other in the total amount of money required to purchase the entire game A.

As described above, in the exemplary embodiment, game points are given on the basis of the result of a user playing a game (an operation during play and the result of the operation), and the price of a next game is discounted using the given game points. This motivates the user to play a purchased game, and therefore enables the user to enjoy the game more. Further, the greater the skill in the game, the more game points the user earns. This makes it possible to enhance the motivation to improve the skill in the game. Further, the greater the number of the game applications owned by the user, the more opportunities the user has to earn game points. This makes it possible to increase a discount on a next game application when purchasing it. The user can purchase a game application at a price lower than the list price. This makes it easier for the user to purchase a game application, and enables the seller of a game application to broaden sales opportunities. Further, the developer of a game application can analyze, based on the game points earned by users: how much the game has been actually played; whether or not the level of difficulty of the game is appropriate; whether or not the game is enjoyed by the users; and the like. Thus, the developer can utilize the analyses for the development of a game application.

In the exemplary embodiment, earned game points are used to discount another game application when purchasing it, but the game application cannot be purchased with the game points alone. That is, the discounted price does not become “0”. The game points that can be used may be limited, or the game points that can be earned may be limited, so that the discounted price does not become “0”. As described above, game points are used to discount the price of another game application, but not used in exchange for the game application. This makes it possible to secure a certain profit or more for the game seller.

It should be noted that the settlement in the charging process performed by the selling server 30 may be made not only by a credit card but also by any method using actual currency or what has a value equivalent thereto (what has the function of mediating the distribution of articles and can be used for various purposes in the general public or in a particular domain). For example, the settlement may be made using IC card electronic money of a prepaid type (in a prepayment form), or the settlement may be made using a prepaid card. Alternatively, the settlement may be made using an external settlement service. Yet alternatively, the settlement may be made by transfer to a bank account such as online banking.

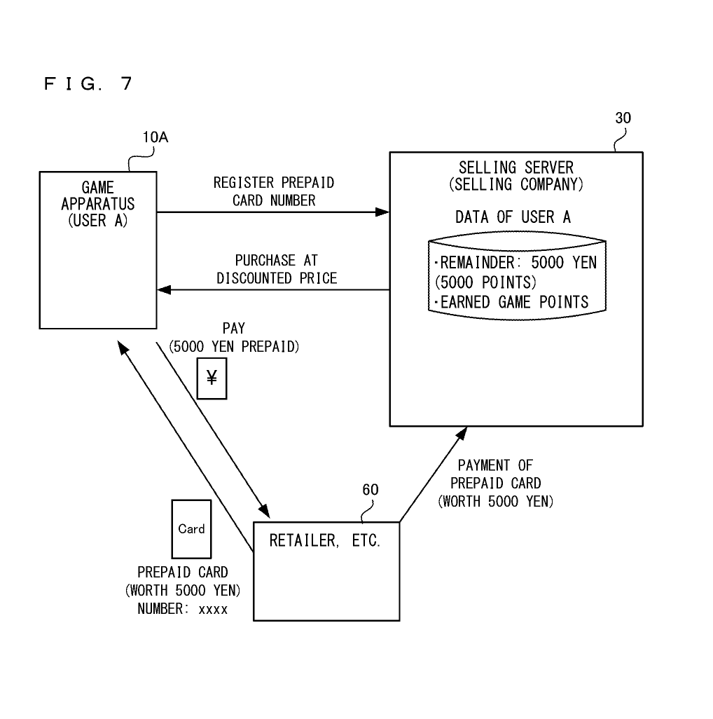

FIG. 7 is a diagram illustrating a settlement method using a prepaid card. As shown in FIG. 7, the user A purchases a prepaid card from a retailer or the like in advance. For example, the user A purchases a 5000-yen prepaid card. The user A registers in the selling server 30 a number written in the purchased prepaid card, thereby saving 5000 yen worth of points (different from game points for a discount as described above) in the selling server 30. When a game application is purchased, a settlement is made by subtracting points from the saved 5000 yen worth of points. That is, when the user A purchases a game application whose list price is 100 yen, if there is no discount using game points, a settlement is made by subtracting 100 points from 5000 points, and the purchase of the game application is completed. If, on the other hand, there is a discount using game points (for example, 50 points), the discounted price of the game application whose list price is 100 yen is 50 yen. Then, a settlement of the amount of this discounted price is made. Specifically, 50 points are subtracted from the saved 5000 points, which leaves 4950 points, and the game application is provided to the user.

In addition, in the above embodiment, each mini-game included in the game A is discounted using game points as described above when additionally purchased. In another embodiment, a purchase target may be anything.

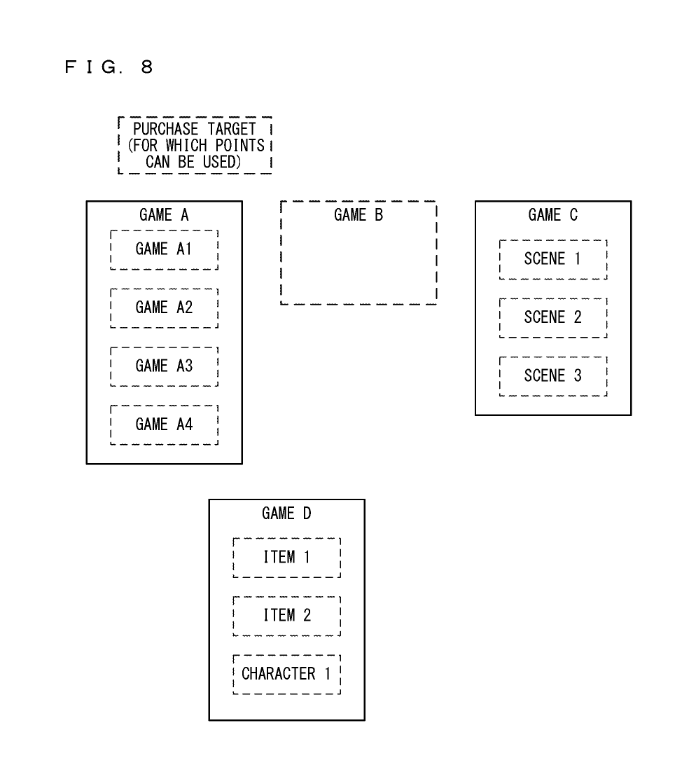

FIG. 8 is a diagram showing examples of a purchase target for which game points can be used. For example, as shown in FIG. 8, a purchase target to be discounted using the game points earned by playing the game A1 may be a game B different in type from the game A. Alternatively, a scene in a game C (a certain scene in the game C, which may be a certain area on a map or may be a stage) may be discounted using game points when purchased. For example, the user may earn game points by playing a scene 1 in the game C, and the game points may be used to discount data (a key, a program, and the like) for enabling the use of a scene 2 or the like, which is an extension function of the game C, when purchasing the data. Alternatively, a purchase target whose price is to be discounted using game points may be an item 1 or a character 1 in a game D. For example, the price of an item or the like (data) used in the game D may be discounted using the game points earned by playing the game A1.

In addition, another embodiment is not limited to a game application, but may be any other application. That is, an application of which the result of the execution varies depending on the operation of the user may be executed, whereby points based on the result of the execution are given. The price (list price) of a predetermined purchase target (selling target) is discounted by subtracting therefrom an amount of money based on the given points, and the discounted price is presented to the user. Then, the discounted price is charged.

In the above embodiment, it is assumed that the selling server 30 performs most of the processing described above. In another embodiment, the game apparatus 10 may perform some of the processing to be performed by the selling server 30.

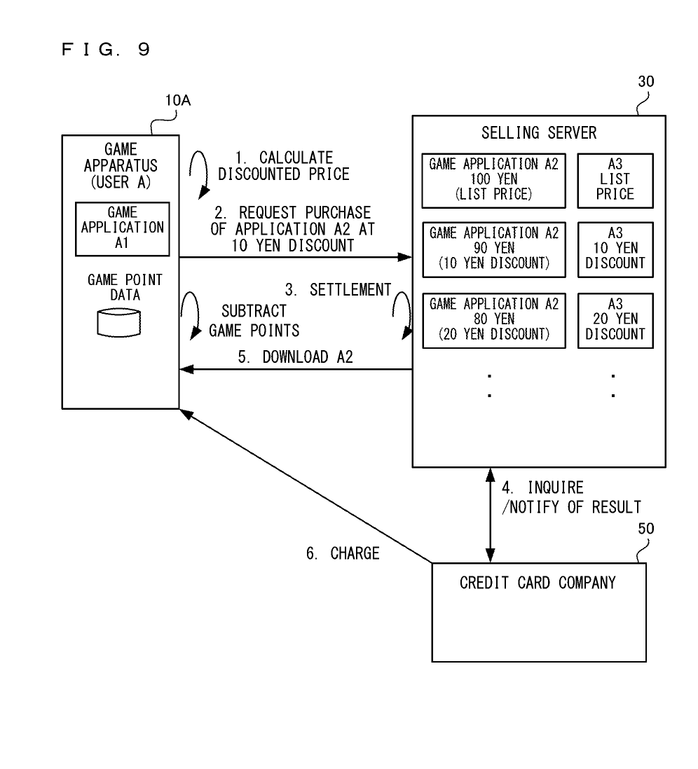

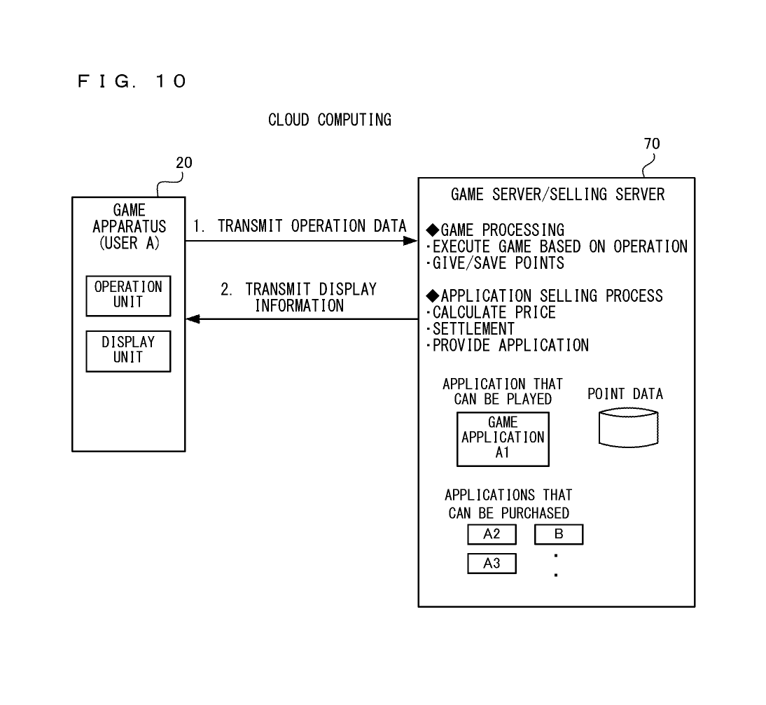

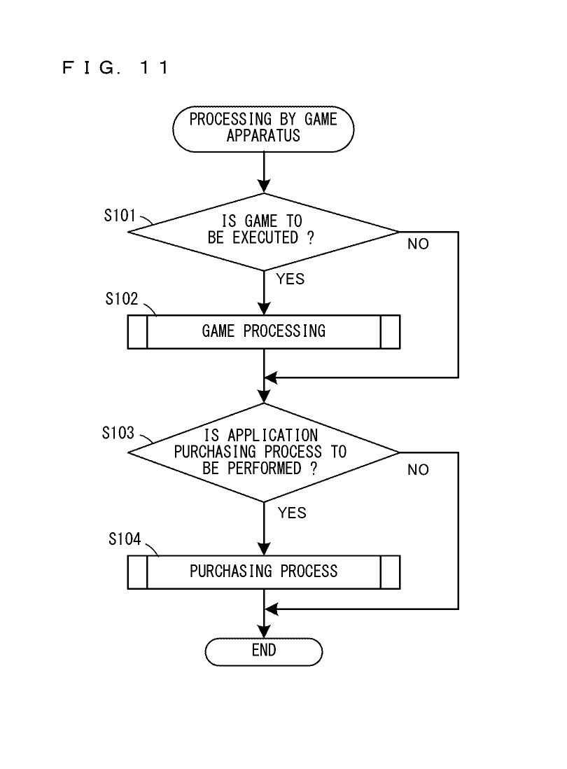

FIG. 9 is a diagram showing an overview of a selling system according to another embodiment. As shown in FIG. 9, the game application A1 is executed in the game apparatus 10A, and game points based on the result of the execution of the game application A1 are earned and saved as game point data in the game apparatus 10A. In the game apparatus 10A, as well as the price of the game application A1, those of the game applications A2 to A4 are stored, and the game apparatus 10A calculates a discounted price by subtracting from each list price the number of game points indicated by the game point data. Meanwhile, in the selling server 30, a plurality of game applications A2 having the same content are prepared, and the prices of the game applications A2 are different from one another. For example, the game application A2 for 100 yen (the list price), the game application A2 for 90 yen (a 10 yen discount), and the game application A2 for 80 yen (a 20 yen discount) are prepared. These applications have the same content, but are managed as different applications (are assigned different IDs). The game apparatus 10A transmits to the selling server 30 a request for the purchase of the game application A2 (the game application A2 for 90 yen) for a discounted price (a 10 yen discount) that has been calculated. The selling server 30 charges the discounted price (makes a settlement for the discounted price) in accordance with the request and transmits to the game apparatus 10A the game application A2 for 90 yen (a 10 yen discount). It should be noted that the charging is performed by a method similar to that described above. In the system shown in FIG. 9, the selling server 30 does not need to perform a discounting process, and therefore only needs to store the same applications for different prices.

In addition, in another embodiment, the above system may be achieved by a distributed network system such as so-called cloud computing. FIG. 10 is a diagram showing an example of a system using cloud computing, according to another embodiment.

As shown in FIG. 10, a game apparatus 20 includes an operation unit and a display unit. Operation data based on an operation performed on the operation unit is transmitted to a game server/selling server 70 via a network. The game server/selling server 70 is a server that performs game processing and the process of selling a game application. The game server/selling server 70 is a system including a plurality of servers. Having received the operation data, the game server/selling server 70 executes game processing based on the operation data. For example, the game server/selling server 70, for example, constructs a game space and causes a player character in the game space to move on the basis of the operation data. Then, the game server/selling server 70 transmits the result of the game processing to the game apparatus 20, and a game image is displayed on the display unit of the game apparatus 20. Further, the game server/selling server 70 gives game points in accordance with the result of the game processing and saves the given game points in the game server/selling server 70. The game server/selling server 70 executes the process described above of selling a game application (the process of calculating a discounted price, the charging process, and the process of providing an application that is a purchase target). The actual game processing is performed in the game server/selling server 70, and therefore, the process of providing an application that is a purchase target is the process of allowing the user A to use the application that is the purchase target. As described above, the above system may be achieved by a cloud computing system in which a server (one or more servers) on a network performs almost all the processing except for input and output.

(Detailed Flow)

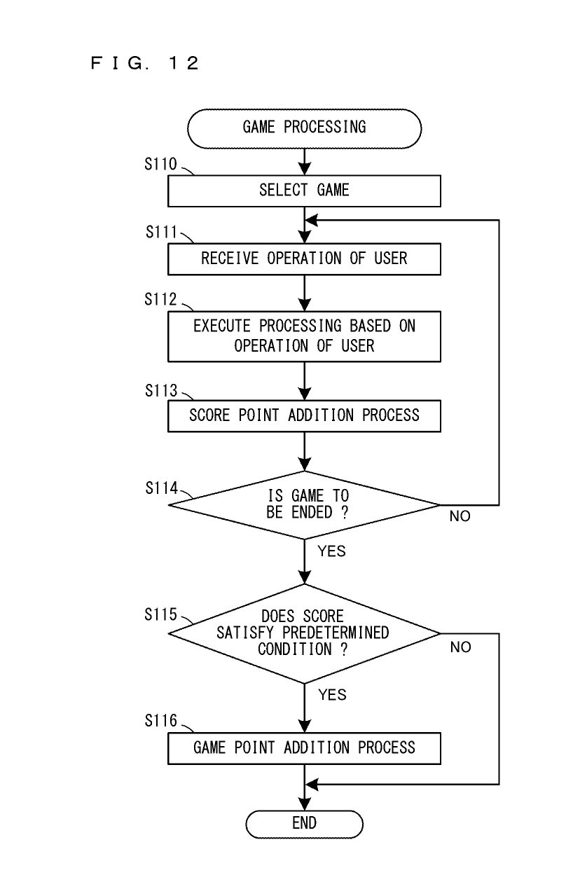

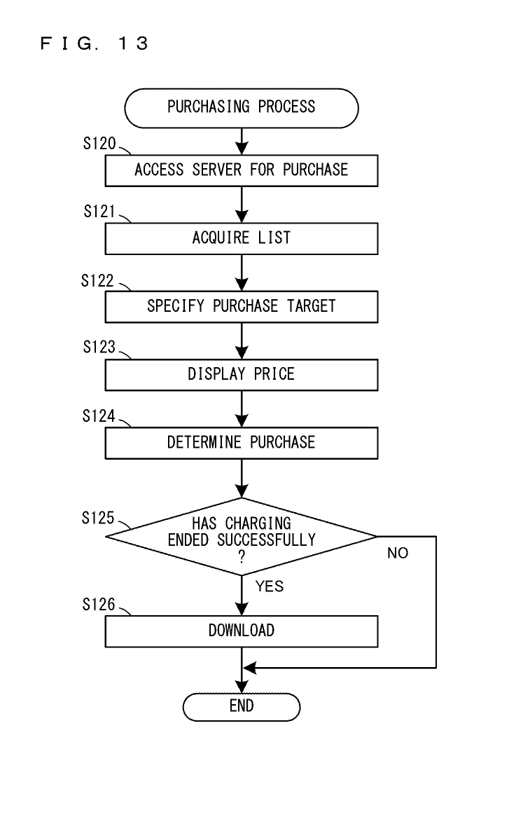

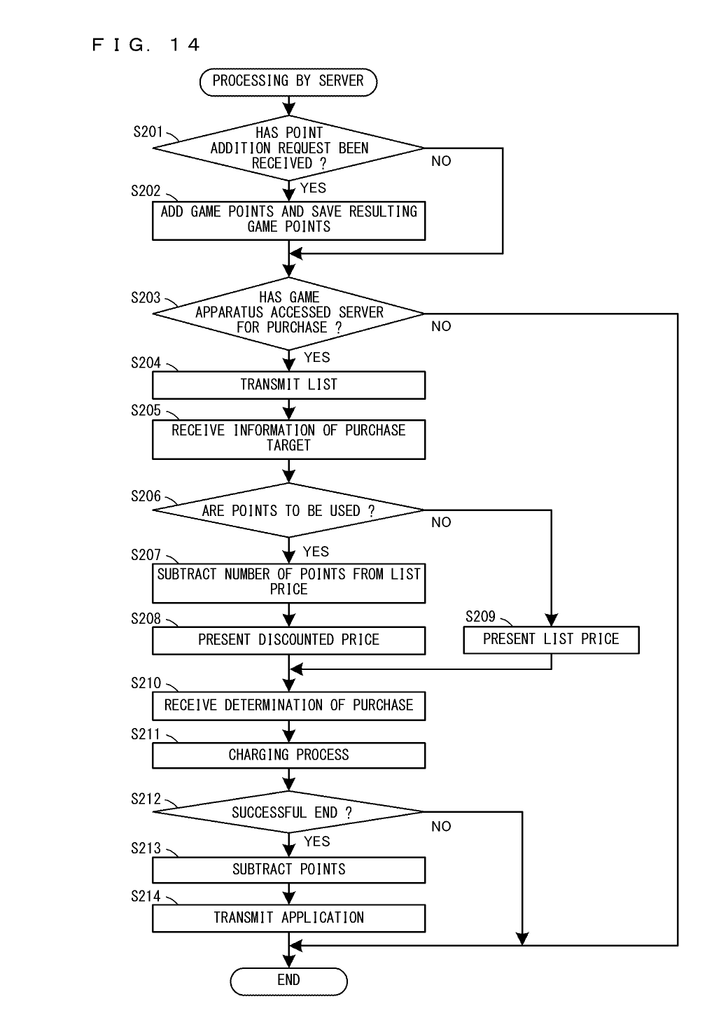

Next, descriptions are given of the details of the processing performed by the game apparatus 10 and the selling server 30 of the system 1 shown in FIG. 1. First, the processing performed by the game apparatus 10 is described. FIG. 11 is a flow chart showing the details of the processing performed by the game apparatus 10. FIG. 12 is a flow chart showing the details of game processing (step S102) in FIG. 11. FIG. 13 is a flow chart showing the details of a purchasing process (step S104) in FIG. 11. The CPU of the game apparatus 10 loads a program stored in the non-volatile memory into the RAM to execute it, thereby executing the processes shown in FIGS. 11 to 13.

As shown in FIG. 11, the game apparatus 10 determines whether or not a game is to be executed (step S101). For example, the game apparatus 10 displays a menu screen and determines whether or not the user has performed on the menu screen the operation of executing a game. If having determined that a game is to be executed (step S101: YES), the game apparatus 10 executes game processing (step S102). The details of the game processing will be described later.

If having ended the game processing, or if having determined in step S101 that a game is not to be executed (step S101: NO), the game apparatus 10 determines whether or not an application purchasing process is to be performed (step S103). For example, the game apparatus 10 displays a menu screen and determines whether or not the user has performed on the menu screen the operation of performing the application purchasing process. If having determined that the application purchasing process is to be performed (step S103: YES), the game apparatus 10 executes the purchasing process (step S104). If having determined that the application purchasing process is not to be performed (step S103: NO), the game apparatus 10 ends the processing shown in FIG. 11. The details of the purchasing process will be described later.

(Game Processing)

Next, with reference to FIG. 12, the details of the game processing (step S102) in FIG. 11 are described.

First, the game apparatus 10 selects a game to be executed (step S110). For example, the game apparatus 10 displays a list of games that can be executed, thereby allowing the user to select one of the games. If the user has selected one of the games, the game apparatus 10 executes the selected game program and receives the operation performed by the user on the operation unit of the game apparatus 10 (step S111). Next, the game apparatus 10 executes processing based on the operation performed by the user on the operation unit (step S112). For example, in accordance with the operation performed on the operation unit, the game apparatus 10 causes a player character to move in a game space, and causes the player character to take a predetermined action.

Then, the game apparatus 10 performs a score point addition process in accordance with the result of the execution in step S112 (step S113). Here, the game is assumed where the user can score points on the basis of the result of the execution of the processing based on the operation of the user. If the operation of the user has satisfied a predetermined condition, the game apparatus 10 adds points to the score. If the operation of the user has not satisfied the predetermined condition, the game apparatus 10 does not add points to the score. The predetermined condition is a condition that varies depending on the execution state of the game. For example, in a game of defeating an enemy character, the predetermined condition is a condition determined by the position of the enemy character at that time, the type of an attack operation for defeating the enemy character, or the like. In step S113, it is determined whether or not the operation of the user has satisfied the predetermined condition (whether or not an appropriate operation has been performed in a certain scene), and points are added to the score in accordance with the result of the determination. Next, on the basis of whether or not the user has performed the operation of ending the game, the game apparatus 10 determines whether or not the game is to be ended (step S114). If having determined that the game is not to be ended (step S114: NO), the game apparatus 10 executes the process of step S111 again. The processes of steps S111 to S113 are repeatedly performed, whereby the operation of the user is repeatedly performed until the end of the game, and points are added to the score in accordance with the operation.

If having determined that the game is to be ended (step S114: YES), the game apparatus 10 determines whether or not the score satisfies a predetermined condition (whether or not the score is a predetermined score or higher) (step S115). If the score does not satisfy the predetermined condition (step S115: NO), the game apparatus 10 ends the game processing shown in FIG. 12. If, on the other hand, the score satisfies the predetermined condition (step S115: YES), the game apparatus 10 performs a game point addition process (step S116).

In the game point addition process in step S116, the process is performed of adding game points as described above. For example, the game apparatus 10 calculates game points in accordance with the score of the game, transmits to the selling server 30 a request to add the game points, and adds the game points earned as a result of the current game. It should be noted that if the game apparatus 10 cannot access the selling server 30 at the present moment, the game apparatus 10 may access the selling server 30 later. If the game point addition process has ended, the game apparatus 10 ends the game processing shown in FIG. 12.

(Purchasing Process)

Next, with reference to FIG. 13, the details of the purchasing process (step S104) in FIG. 11 are described.

The game apparatus 10 first accesses the selling server 30 (step S120) and acquires a list of applications that can be purchased from the selling server 30 (step S121). Next, the game apparatus 10 specifies a purchase target in accordance with the operation of the user (step S122). Specifically, the user selects an application that is a purchase target, and specifies whether or not to use the game points held by the user and also specifies the number of the game points to be used. In step S122, the game apparatus 10 transmits, to the selling server 30, various types of information specified by the user. In accordance with the process of step S122, the selling server 30 transmits information of the offered price of the application (a discounted price if there is a discount, or a predetermined price if there is no discount).

Next, the game apparatus 10 displays the price of the application on the basis of the information received from the selling server 30 (step S123), and in accordance with the operation of the user, notifies the selling server 30 of the determination of the purchase of the application (step S124). This notification includes information of a credit card number, a name, and the like input by the user. The selling server 30 performs a charging process in accordance with the process of step S124 and transmits the result of the charging process to the game apparatus 10. Next, the game apparatus 10 determines whether or not the charging has ended successfully (step S125). If the charging has ended successfully (step S125: YES), the game apparatus 10 downloads the purchased application (step S126). If the charging has not ended successfully (step S125: NO), the game apparatus 10 performs display indicating that the charging has not ended successfully. Thereafter, the game apparatus 10 ends the purchasing process shown in FIG. 13.

(Processing by Server)

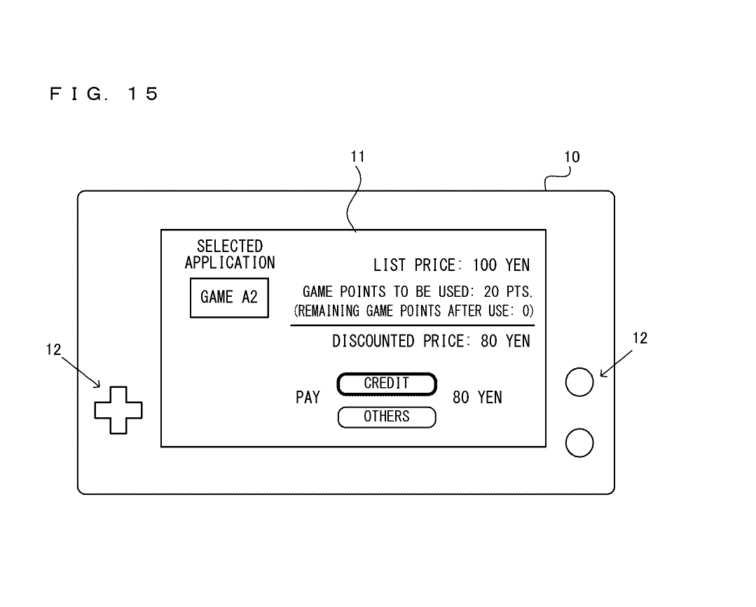

Next, with reference to FIG. 14, the details of the processing performed by the selling server 30 are described. FIG. 14 is a flow chart showing the details of the processing performed by the selling server 30. The selling server 30 has stored therein a program for performing the processing in FIG. 14, and the CPU of the selling server 30 loads the program into the RAM to execute it, thereby executing the processing shown in FIG. 14.

The selling server 30 determines whether or not a point addition request has been received from the game apparatus 10 (step S201). If the point addition request has been received (step S201: YES), the selling server 30 adds, to the game points saved in association with the game apparatus 10 having made the request, the number of game points that is included in the request and is to be currently added, and the selling server 30 saves the resulting game points (step S202).

If having performed the process of step S202 or having determined in step S201 that the point addition request has not been received (step S201: NO), the selling server 30 determines whether or not the game apparatus 10 has accessed the selling server 30 to purchase an application (step S203). If the game apparatus 10 has not accessed the selling server 30 to purchase an application (step S203: NO), the selling server 30 ends the processing shown in FIG. 14.

If the game apparatus 10 has accessed the selling server 30 to purchase an application (step S203: YES), the selling server 30 transmits to the game apparatus 10 a list of applications that can be purchased by the user (step S204). Here, the selling server 30 acquires from a database a predetermined price (the list price) of each application and the game points currently held by the game apparatus 10 (the user) having accessed the selling server 30, and transmits the above information to the game apparatus 10. Next, the selling server 30 receives information of a purchase target specified by the user (step S205).

The information received in step S205 includes information regarding: the application that is the purchase target; whether or not game points are to be used; and the number of the game points to be used. The selling server 30 determines, on the basis of the received information, whether or not game points are to be used (step S206).

If game points are to be used (step S206: YES), the selling server 30 calculates a discounted price by subtracting from the predetermined price of the purchase target (selling target) the number of the game points to be used (step S207), and transmits information of the discounted price to the game apparatus 10 (step S208). If game points are not to be used (step S206: NO), the selling server 30 transmits information of the predetermined price to the game apparatus 10 (step S209).

If having executed the process of step S208 or the process of step S209, the selling server 30 is notified by the game apparatus 10 of the determination of the purchase of the application (step S210). The notification includes information of a credit card number, a name, and the like of the user of the game apparatus 10. The selling server 30 performs a charging process on the basis of the information (step S211).

In the charging process in step S211, the selling server 30 transmits to the credit card company server 50 the received information of a credit card number, a name, and the like, and the received information of the price to be charged (a discounted price if there is a discount, or the list price if there is no discount), and, for example, inquires whether or not the price can be charged. If the credit card company server 50 has notified the selling server 30 of a successful end (step S212: YES), the selling server 30 subtracts the currently used game points (step S213) and transmits the game application that is the purchase target to the game apparatus 10 (step S214). If the credit card company server 50 has not notified the selling server 30 of a successful end (step S212: NO), the selling server 30 transmits, to the game apparatus 10, information indicating that the charging process has been unsuccessful, and the selling server 30 ends the processing shown in FIG. 14.

FIG. 15 is a diagram showing an example of an image displayed on a display unit 11 of the game apparatus 10. For example, as a result of performing the process of step S123 in FIG. 13, the image shown in FIG. 15 is displayed.

As shown in FIG. 15, on the display unit 11 of the game apparatus 10, the following are displayed: the list price of the game application A2 selected as the purchase target by the user; the number of the game points to be currently used; and the discounted price obtained by using the game points. The user selects a settlement method (a settlement using a credit card, or a settlement by another method) and inputs predetermined information, using an operation unit 12, thereby determining the purchase of the game application A2. It should be noted that the operation unit 12 is operated also when the game is played.

As described above, the user executes a game and earns game points, and thereby can purchase a new game at a price lower than the list price using the earned game points.

It should be noted that the flow charts shown in FIGS. 11 to 14 are merely illustrative. Thus, the processing order of the steps may be changed, or a process may be added, changed, or deleted, so long as similar results are obtained. Further, the processes of all the steps may be performed by either one of the game apparatus 10 and the selling server 30, or some or all of the processes may be performed by any other apparatus.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. An information processing system, including a user terminal and a server, for selling a selling target, the information processing system comprising:
an execution unit configured to execute a first application in accordance with an operation of a user;
a generation unit configured to, in accordance with a result of the execution of the first application based on the operation of the user, generate point data indicating a point to be used to discount the selling target;
a calculation unit configured to calculate, as discounted price data, a discounted price by subtracting a discount based on the point data from a predetermined price for purchasing the selling target; and
a settlement execution unit configured to make a settlement for the selling target on the basis of the discounted price data.

2. The information processing system according to claim 1, wherein
the selling target can be used in the user terminal.

3. The information processing system according to claim 1, further comprising
a storage control unit configured to store the point data in a storage unit so that the point data can be used even after the execution of the first application ends, wherein
the calculation unit reads at predetermined timing the point data stored in the storage unit, and calculates the discounted price data using the read point data.

4. The information processing system according to claim 1, wherein
the point data is generated on the basis of at least any one of the number of times the first application has been executed, an execution time of the first application, and data that varies depending on the operation of the user during the execution of the first application.

5. The information processing system according to claim 1, further comprising
a control unit configured to repeat processing performed by the execution unit and the generation unit, wherein
the generation unit adds currently generated point data to previously generated point data.

6. The information processing system according to claim 1, further comprising
a presentation unit configured to present to the user the discounted price indicated by the discounted price data calculated by the calculation unit.

7. The information processing system according to claim 1, wherein
the settlement execution unit makes the settlement on the basis of the discounted price data in accordance with a determination of a purchase of the selling target, the determination made by the user.

8. The information processing system according to claim 1, wherein
the calculation unit calculates the discounted price data so that the discounted price does not become 0.

9. The information processing system according to claim 1, wherein
the selling target is a second application different from the first application.

10. The information processing system according to claim 9, wherein
the execution unit can execute also the second application; and
the generation unit generates the point data also in accordance with a result of the execution of the second application, in addition to the result of the execution of the first application.

11. The information processing system according to claim 1, wherein
the selling target is data for providing an extension function of the first application.

12. The information processing system according to claim 1, wherein
the selling target is data to be used in a second application different from the first application.

13. The information processing system according to claim 11, wherein
the execution unit can execute also the extension function of the first application; and
the generation unit generates the point data also in accordance with a result of the execution of the extension function of the first application, in addition to the result of the execution of the first application.

14. The information processing system according to claim 1, further comprising
a selection unit configured to allow the user to choose whether or not to use the point data when purchasing the selling target, wherein
if the user has chosen to use the point data, the settlement execution unit makes the settlement on the basis of the discounted price data.

15. The information processing system according to claim 1, wherein
the settlement execution unit makes the settlement using actual currency by a credit card, a prepaid card, prepaid electronic money, bank transfer, an external settlement service, or the like.

16. An information processing system for selling a selling target, the information processing system comprising:
an execution result acquisition unit configured to acquire a result of an execution of a first application based on an operation performed by a user;
a point data acquisition unit configured to, in accordance with a result of the execution of the first application based on the operation of the user, acquire point data indicating a point to be used to discount the selling target;
a calculation unit configured to calculate, as discounted price data, a discounted price by subtracting a discount based on the point data from a predetermined price for purchasing the selling target; and
a settlement execution unit configured to make a settlement for the selling target on the basis of the discounted price data.

17. A non-transitory computer-readable storage medium having stored therein an information processing program to be executed by a computer of an information processing system for selling a selling target, the information processing program causing the computer to execute:
acquiring a result of an execution of a first application based on an operation performed by a user;
in accordance with a result of the execution of the first application based on the operation of the user, acquiring point data indicating a point to be used to discount the selling target;
calculating, as discounted price data, a discounted price by subtracting a discount based on the point data from a predetermined price for purchasing the selling target; and
making a settlement for the selling target on the basis of the discounted price data.

18. An information processing method to be executed by an information processing system, including a user terminal and a server, for selling a selling target, the information processing method comprising:
executing a first application in accordance with an operation of a user;
in accordance with a result of the execution of the first application based on the operation of the user, generating point data indicating a point to be used to discount the selling target;
calculating, as discounted price data, a discounted price by subtracting a discount based on the point data from a predetermined price for purchasing the selling target; and
making a settlement for the selling target on the basis of the discounted price data.
